(19) United States
(12) Patent Application Publication
(10) Pub. No.: US 2007/0112548 A1
(43) Pub. Date: May 17, 2007

(54) Methods for fabricating micro-to-nanoscale devices via biologically-induced solid formation on biologically-derived templates, and micro-to-nanoscale structures and micro-to-nanoscale devices made thereby

(75) Inventors: Matthew Benjamin Dickerson, Smyrna, GA (US); Kenneth Henry Sandhage, Roswell, GA (US); Rajesh Nalik, Dayton, OH (US); Morley O. Stone, Bellbrook, OH (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 11/358,342

(22) Filed: Feb. 21, 2006

Related U.S. Application Data
(60) Provisional application No. 60/654,553, filed on Feb. 18, 2005.

(51) Int. Cl. G06G 7/48; G06G 7/58

(52) U.S. Cl. 703/11

(57) ABSTRACT

The focus of this invention is the combined use of: i) one or more biological agents to promote the precipitation of one or more desired solids onto ii) a biologically-assembled 3-D microscale-to-nanoscale structure. That is, the solid precipitation and the 3-D structural assembly are both conducted with the aid of biology. The biologically-derived 3-D structures may assembled by a biological organism, by a component of a biological organism, by a biological molecule, or by combinations thereof. One or more biological agents is/are used to promote the precipitation of one or more new solids onto the biologically-derived 3-D structure.

### RELATED U.S. APPLICATION DATA

This application claims the benefit of U.S. Provisional Application No. 60/654,553, filed 18 Feb. 2005, which is incorporated herein by reference.

### GOVERNMENT INTERESTS

The present invention was made with government support by the U.S. Air Force under Contract No. F49620-03-1-0421 awarded by the Department of Defense (DARPA). The Government has certain rights in this invention.

### FIELD OF THE INVENTION

The present invention is in the field of shaped three-dimensional (3-D) microscale-to-nanoscale structures and 3-D microscale-to-nanoscale devices fabricated by utilizing a biological agent to induce the precipitation of one or more solid materials onto a biologically-derived 3-D microscale-to-nanoscale template. The micro-to-nanoscale template may possess a shape that is naturally occurring, one that is modified through environmental changes, one that is modified through genetic changes, or one that is obtained through the use of a biomolecule, or combinations thereof.

### BACKGROUND OF THE INVENTION

Intensive global research and development activity is underway to develop methods for assembling microscale-to-nanoscale devices with complex shapes and fine features for a host of biomedical, telecommunications, computing, environmental, aerospace, automotive, manufacturing, energy production, chemical/petrochemical, defense, and numerous other applications. Microscale devices have already found use as sensors in automotive and some medical applications. However, a far larger untapped potential exists for the use of new micro-to-nanoscale devices in a variety of advanced applications, such as in: i) medicine (e.g., targeted drug or radiation delivery; rapid clinical and genomic analyses; in vitro sensors; micro/nanoscale surgical tools, pumps, valves, and components used in biomedical imaging, etc.), ii) transportation and energy production (e.g., new sensors and actuators for enhanced engine performance and energy utilization; micro/nanoscale components for automotive, diesel, jet, or rocket engines; micro/nanoscale components for turbines used in energy conversion or generation; micro/nanoscale reactors, pumps, bearings, etc.), iii) communications and computing (e.g., micro/nanoscale optical devices, actuators, switches, transducers, etc.), iv) environmental remediation (e.g., active micro/nanostructured filter or membrane materials for the scrubbing of gas exhausts for pollutant gases or particles or for the treatment of wastewater streams), v) agriculture (e.g., micro/nanoscale carriers for fertilizers or for delivering nutrients to animals),

vi) production/manufacturing of food, chemical, and materials (e.g., micro/nanoscale on-line sensors, reactors, pumps, dies, etc.), and a variety of consumer products (e.g., for lighting, portable electrical devices, water purification, etc.).

Despite the recognized technological and economic significance of new micro-to-nanoscale devices, commercial fabrication of such micro-to-nanoscale devices has largely been based on so-called “top-down” approaches that involve the generation of fine-scaled features within macroscopic materials, using techniques such as photolithography or reactive ion etching (e.g., for the formation of microelectronic devices on silicon-based wafers). However, in order to produce a complex three-dimensional (3-D) nonplanar microscale structure, such top-down processing requires the generation of numerous two-dimensional layers with different shapes. Such 2-D layer-by-layer processing is not well-suited for 3-D microfabrication, owing to the large number of steps required to generate a complex 3-D shape along with the geometric and chemical limitations of such processing (e.g., the difficulty in fabricating smoothly curved 3-D surfaces with a wide range of non-silicon-based compositions). Alternate methods are needed for assembling large numbers of complex 3-D micro-to-nanoscale structures with a variety of chemistries at low cost.

Elegant examples of large scale fabrication of 3-D microstructures with nanoscale features can be found in nature. Certain microorganisms are adept at assembling biomineralized structures with precise shapes and fine (sub-micron) features. For example, diatoms are single-celled algae that generate an exceptional variety of intricate microshells based on silicon dioxide. Each diatom microshell (a frustule) possesses a 3-D shape decorated with a regular pattern of fine features (10² nm pores, channels, protuberances, ridges, etc.) that are species specific; that is, the frustule shapes and fine features are under genetic control. The frustule morphology for a given diatom species is replicated with high fidelity upon biological reproduction. Consequently, enormous numbers of identically-shaped frustules can be generated by sustained reproduction of a single parent diatom (e.g., more than 1 trillion daughter diatoms with similar frustules could be produced from a parent diatom after only 40 reproduction cycles). Such massively parallel and genetically precise 3-D nanoparticle assembly has no man-made analog. With tens of thousands of extant diatom species, a rich variety of frustule morphologies exists for potential device applications. This range of diatom frustule morphologies may be further enhanced through genetic modification of diatoms. The recent mapping of the genome of the diatom Thalassiosira pseudonana is a first step in this direction. A number of other organisms (e.g., silicoflagellates, radiolarians, sponges, various plants, mollusks) also form controlled silica-based microstructures. Biomineralized calcium carbonate-based structures are also formed by a variety of organisms (e.g., algae, mollusks, arthropods, echinoderms, bacteria, plants). For example, coccolithophorids are micro-algae that form a rich variety of intricate 3-D calcium carbonate-based microshells. While a wide variety of shapes and fine features can be found among the various biomineralized structures, the natural chemistries of such structures are largely limited to calcium compounds (carbonates, phosphates, oxalates, halides), silica, or iron oxides. Such limited chemistries severely restrict the properties (e.g., electronic, biomedical, chemical/catalytic, optical, thermal) of such micro/nanostructures for device applications. If such micro/nanostructures could be converted into a much wider range of chemistries, without a loss of the biologically-derived shapes or fine features, then the massively parallel and genetically precise 3-D self-assembly characteristics of nature could be synergistically coupled with such chemical tailoring to enable the mass production of enormous numbers of microscale-to-nanoscale devices with a diverse range of properties for numerous applications.

Recent work by Sandhage, et al. has shown how gas/solid reactions may be used to convert the frustules of diatoms into non-silica-based compositions without a loss of the starting frustule shapes and fine features. Net displacement reactions of the following type have been used to convert SiO₂-based diatom frustules into MgO-based or TiO₂-based compositions:
2Mg(g)+SiO₂(s)=>2MgO(s)+{Si} (1)
TiF₄(g)+SiO₂(s)=>TiO₂(s)+SiF₄(g) (2)
where {Si} refers elemental silicon or silicon dissolved in a magnesium compound or alloy. While the shapes and fine features of the MgO-based or TiO₂-based frustule replicas were well preserved, these reactions were conducted at elevated temperatures (e.g., 650-900° C. for reaction (1); 250-350° C. for reaction (2)). Gas/solid reactions of this type are also limited to reactants that are capable of displacing the silicon in SiO₂(s). Because SiO₂ is a relatively stable oxide, the number of potential gaseous reactants is relatively limited. Other chemical modification approaches that do not rely upon high-temperature displacement reactions with the biomineralized template would allow for a wider range of tailored compositions.

Recent work by several authors has demonstrated that biological agents may be used to promote the precipitation of solid materials under ambient conditions. For example, Kroger, et al. have isolated polypeptides (called “silaffins”) and polyamines within the frustules of diatoms that promote the precipitation of microscale-to-nanoscale silica particles. Morse, et al. have isolated polypeptides (called “silicateins”) that promote the precipitation of silica spicules in sponges. Combinatorial phage display library methods have also been used to identify polypeptides that promote the room-temperature formation of silica, germania, copper oxide, zinc oxide, silver, gold, gallium arsenide, and other semiconductors. Such combinatorial chemical methods are capable of rapidly identifying specific polypeptides (from a library of billions or more candidate polypeptides) that promote the precipitation of a wide variety of solid materials (ceramics, metals, polymers) from precursor solutions. However, such biochemically-induced precipitation tends to result in the formation of solid structures with shapes that are relatively simple when compared with the intricate 3-D microshells assembled by diatoms and other micro-organisms. Biochemically-induced precipitation needs to be integrated into a process that allows for the large scale production of identical micro-to-nanoscale structures with a variety of well-controlled and intricate 3-D shapes and fine features.

### SUMMARY OF THE INVENTION

The focus of this invention is the combined use of: i) one or more biological agents to promote the precipitation of one or more desired solids onto ii) a biologically-assembled 3-D microscale-to-nanoscale structure. That is, the solid precipitation and the 3-D structural assembly are both conducted with the aid of biology. The biologically-derived 3-D structures may assembled by a biological organism, by a component of a biological organism, by a biological molecule, or by combinations thereof. One or more biological agents is/are used to promote the precipitation of one or more new solids onto the biologically-derived 3-D structure. Different biological entities can be used to control the processes of: i) assembling the 3-D microscale-to-nanoscale structures and ii) forming one or more new solids onto the said microscale-to-nanoscale structures. In this manner, the attractive characteristics of biologically-derived structural assembly (massive parallelism, genetic precision, direct 3-D shape formation, control over fine features, environmentally-benign assembly) can be merged with the attractive characteristics of biologically-promoted precipitation (precipitation of solids with specific chemistries and/or specific crystalline or amorphous structures and/or specific crystallographic orientations under ambient conditions).

The present invention provides biologically-derived microscale-to-nanoscale structures and biologically-derived microscale-to-nanoscale devices for a variety of uses, including biomedical, telecommunications, computing, agricultural, environmental, aerospace, automotive, manufacturing, chemical/petrochemical, energy production, and defense applications. The term, “microscale-to-nanoscale” is defined herein to include that which can be practically measured using a micrometer scale (e.g., 1.0 to 1,000 micrometers) and that which can be practically measured using a nanometer scale (e.g., 1.0 to 1,000 nanometers). The term, “micrometer scale to nanometer scale” may also be used. Specific examples of microscale-to-nanoscale devices include, but are not limited to, microcatalysts, microreactors, microcapsules, microsensors, microtags, microactuators, microtransducers, microbearings, microlenses, microdiffraction gratings, microrefraction gratings, microemitters, microphosphors, micromirrors, microfilters, micromembranes, microneedles, microdies, microhinges, microswitches, microbearings, micronozzles, and microvalves.

The present invention provides microscale-to-nanoscale mineralized templates with desired shapes and fine features through the use of biological organisms that assemble such templates, or through the use of components of biological organisms that assemble such mineralized templates, or through the use of biological molecules that assemble such templates, or combinations thereof. As described herein, “mineralized template” (hereinafter referred to as “template” or “microscale-to-nanoscale template”) refers to a solid chemical element or compound that results from a biological process.

The present invention provides methods for preparing biologically-derived microscale-to-nanoscale structures, and biologically-derived microscale-to-nanoscale devices, with desired chemistries and with desired shapes and features (e.g., pores, channels, nodules, ridges, protuberances, etc.) for such applications. The present invention provides the desired chemistries of these structures and devices through the use of biological agents that induce the precipitation of a solid material (ceramic, metal, semiconductor, organic material, or a composite of one or more of these materials) onto a biologically-derived microscale-to-nanoscale template that possesses a desired shape and fine features.

The present invention provides methods for attaching precipitation-inducing biological agents to biologically-derived microscale-to-nanoscale templates. Accordingly, the invention provides methods for precipitating a solid material onto a precipitation-inducing biological agent and further provides methods for precipitating a solid material onto biologically-derived microscale-to-nanoscale templates.

### BRIEF DESCRIPTION OF THE DRAWINGS

FIG. 1a is a secondary electron image of a germania-bearing diatom microshell template produced through the use of a chimeric peptide attached to the diatom microshell surface.

FIG. 1b is an energy-dispersive x-ray (EDX) pattern of a germania-bearing diatom microshell template produced through the use of a chimeric peptide attached to the diatom microshell surface.

FIG. 2a is a secondary electron image of a diatom microshell template exposed to a “control” treatment.

FIG. 2b is an energy dispersive x-ray (EDX) pattern of a diatom microshell template exposed to a “control” treatment.

FIG. 3a is a secondary electron image of a germania particle-bearing diatom microshell template produced through the use of covalently attached peptides.

FIG. 3b is a secondary electron image of a germania particle-bearing diatom microshell template produced through the use of covalently attached peptides.

FIG. 3c is a secondary electron image of a germania particle-bearing diatom microshell template produced through the use of covalently attached peptides.

FIG. 3d is an energy dispersive x-ray (EDX) pattern of a germania particle-bearing diatom microshell template produced through the use of covalently attached peptides.

FIG. 4a is a secondary electron image of a diatom microshell template exposed to a “control” treatment.

FIG. 4b is a secondary electron image of a diatom microshell template exposed to a “control” treatment.

FIG. 4c is a secondary electron image of a diatom microshell template exposed to a “control” treatment.

FIG. 4d is an energy dispersive x-ray (EDX) pattern of a diatom microshell template exposed to a “control” treatment.

FIG. 5a is a secondary electron image of a germania particle-bearing diatom microshell produced through the use of covalently attached peptides.

FIG. 5b is a secondary electron image of a germania particle-bearing diatom microshell produced through the use of covalently attached peptides.

FIG. 6a is a secondary electron image of a diatom microshell exposed to a “control” treatment.

FIG. 6b is a secondary electron image of a diatom microshell exposed to a “control” treatment.

### DETAILED DESCRIPTION OF THE EMBODIMENTS

The present invention provides methods for fabricating chemically-tailored microscale-to-nanoscale structures, and microscale-to-nanoscale devices, comprising the steps of: i) obtaining one or more biologically-derived microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the template. The phrase “precursor solutions” refers herein to gas solutions, liquid solutions, solid solutions, or some combination thereof that contain a precursor to the desired solid material.

The present invention provides methods for fabricating chemically-tailored microscale-to-nanoscale structures, and microscale-to-nanoscale devices, comprising the steps of: i) using a biological organism to assemble one or more microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the one or more templates.

The present invention provides methods for fabricating chemically-tailored microscale-to-nanoscale structures, and microscale-to-nanoscale devices, comprising the steps of: i) using a component of a biological organism to assemble one or more microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the one or more templates.

The present invention provides methods for fabricating chemically-tailored microscale-to-nanoscale structures, and microscale-to-nanoscale devices, comprising the steps of: i) using biomolecules to assemble one or more microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the one or more templates.

The present invention provides chemically-tailored microscale-to-nanoscale structures, and microscale-to-nanoscale devices, that are produced by the process comprising the steps of: i) obtaining one or more biologically-derived microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the template.

The present invention provides chemically-tailored microscale-to-nanoscale structures, and microscale-to-nanoscale devices, that are produced by the process comprising the steps of: i) using a biological organism to assemble one or more microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the one or more templates.

The present invention provides chemically-tailored microscale-to-nanoscale structures, and microscale-to-nanoscale devices, that are produced by the process comprising the steps of: i) using a component of a biological organism to assemble one or more microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the one or more templates.

The present invention provides chemically-tailored microscale-to-nanoscale structures, and microscale-to-nanoscale devices, that are produced by the process comprising the steps of: i) using biomolecules to assemble one or more microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the one or more templates. It will be understood by those of ordinary skill in the art that the precipitation of one or more solids may occur onto the biological agent before or after attaching the biological agent to the template. A precipitation reaction is defined as a reaction in which an insoluble substance forms and separates from the solution. See Zumdahl, Chemistry, Chapter 4 (D.C. Heath and Company, Publishers). Thus the precipitation described herein may occur proximal to, distal to, or in contact with the biological agent or the template.

Biologically-Derived Templates

The present invention provides methods for fabricating chemically-tailored microscale-to-nanoscale structures, and microscale-to-nanoscale devices that utilize biologically-derived microscale-to-nanoscale templates with desired shapes and fine features. The fine features may be selected from the group including, but not limited to, pores, channels, nodules, ridges, protuberances, or combinations thereof.

The present invention provides methods for fabricating chemically-tailored microscale-to-nanoscale structures, and microscale-to-nanoscale devices that utilize microscale-to-nanoscale templates with desired shapes and fine features that are generated by naturally-occurring biological organisms or environmentally-modified biological organisms or genetically-modified biological organisms.

The present invention provides chemically-tailored microscale-to-nanoscale structures, and microscale-to-nanoscale devices, with shapes and fine features that are obtained from biologically-derived microscale-to-nanoscale templates.

The present invention provides chemically-tailored microscale-to-nanoscale structures, and microscale-to-nanoscale devices, with shapes and fine features that are obtained from biologically-derived microscale-to-nanoscale templates that are generated by naturally-occurring biological organisms or environmentally-modified biological organisms or genetically-modified biological organisms.

The template generated by the biological organism may be a hard or soft endoskeleton, a portion of a hard or soft endoskeleton, a hard or soft exoskeleton, or a portion of a hard or soft exoskeleton, generated by, or comprising part of, a once-living organism.

The template may be generated by organisms selected from the group of biological kingdoms that includes Monera, Protoctista, Fungi, Animalia, and Plantae. The template may be generated by organisms selected from the group of phyla that includes, but is not limited to, Monera, Dinoflagellata, Haptophyta, Bacillariophyta, Phaeophyta, Rhodophyta, Chlorophyta, Zygnematophyta, Chrysophyta, Rhizopodea, Siphonophyta, Charophyta, Heliozoata, Radiolariata, Foraminifera, Mixomycota, Ciliophora, Basidiomycota, Deuteramycota, Coelenterata, Mycophycophyta, Bryophyta, Tracheophyta, Porifera, Cnidaria, Platyhelminthes, Ectoprocta, Brachiopoda, Annelida, Mollusca, Arthropoda, Sipuncula, Echinodermata, and Chordata. Examples of naturally-occurring templates include, but are not limited to, the silica-based microshells of diatoms, silicoflagellates, radiolarians, and sponges; the calcium carbonate-based microshells of mollusks, coccolithophorids, and echinoderms; and the iron-bearing magnetic crystals generated by magnetotactic bacteria.

The template may be generated by an organism that is genetically modified so as to generate a template with a shape, fine features, or a combination thereof that differ from the template generated by the native (non-genetically-modified) organism.

The template may be generated by an organism that is exposed to conditions that differ from the ambient environment where the living organism is found, so that the organism is induced to generate a template with a shape, fine features, or a combination thereof that differ from the template generated by the native organism in the ambient environment.

The present invention provides methods for fabricating chemically-tailored microscale-to-nanoscale structures, and microscale-to-nanoscale devices that utilize microscale-to-nanoscale templates with desired shapes and fine features that are generated by naturally-occurring components of biological organisms or environmentally-modified components of biological organisms or genetically-modified components of biological organisms.

The present invention provides methods for fabricating chemically-tailored microscale-to-nanoscale structures, and microscale-to-nanoscale devices that utilize microscale-to-nanoscale templates with desired shapes and fine features generated through the use of naturally-occurring biomolecules or environmentally-modified biomolecules or genetically-modified biomolecules that promote the assembly of such templates.

The present invention provides chemically-tailored microscale-to-nanoscale structures, and microscale-to-nanoscale devices, with shapes and fine features that are obtained from biologically-derived microscale-to-nanoscale templates that are generated by naturally-occurring components of biological organisms or environmentally-modified components of biological organisms or genetically-modified components of biological organisms.

The present invention provides chemically-tailored microscale-to-nanoscale structures, and microscale-to-nanoscale devices, with shapes and fine features that are obtained from biologically-derived microscale-to-nanoscale templates generated through the use of naturally-occurring biomolecules or environmentally-modified biomolecules or genetically-modified biomolecules that promote the assembly of such templates.

The microscale-to-nanoscale template may have a shape or fine features that are generated with the use of a biological molecule, or from a portion of a biological molecule, or from a chemically-modified biomolecule, or from a portion of a chemically-modified biomolecule. As used herein, the terms “biological molecule” or “biomolecule” refer to any molecule that is derived from a native biological organism or a biological organism that has been environmentally modified or genetically modified, from a component of a native or environmentally-modified or genetically-modified biological organism, or from an agent that utilizes a native or environmentally-modified or genetically-modified biological organism to multiply.

The microscale to-nanoscale template generated with the use of a biological molecule may have a shape or fine features that are obtained by synthetic patterning. Once patterned, the biomolecule may induce the precipitation of a microscale-to-nanoscale template that assumes the shape of the patterned biomolecule. For example, a silaffin, or a portion of a silaffin, may be patterned via controlled deposition onto an inert substrate. The silaffin may be patterned via a method including, but not limited to, controlled phase separation from a silaffin-bearing solution, direct writing with a tip coated with the silaffin, and printing of the silaffin with an ink jet printer. The patterned silaffin, or patterned portion of a silaffin, may then be exposed to a silicic acid solution so as to precipitate a silica template with the same pattern at that of the silaffin.

The present invention provides methods for fabricating chemically-tailored microscale-to-nanoscale structures, and microscale-to-nanoscale devices, comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the biologically-derived microscale-to-nanoscale template is comprised of a material selected from the group consisting of a solid metal, a solid metal alloy, a solid metal mixture, a solid ceramic, a solid ceramic alloy, a solid ceramic mixture, a solid organic material, a solid organic alloy, a solid organic mixture, or combinations thereof. It will be understood by those of ordinary skill in the art that the precipitation of one or more solids may occur onto the biological agent before or after attaching the biological agent to the template.

The present invention provides methods for fabricating chemically-tailored microscale-to-nanoscale structures, and microscale-to-nanoscale devices, comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the chemical composition of the said template is selected from the group consisting of oxides, carbonates, phosphates, oxalates, citrates, halides, sulfides, and sulfates.

The present invention provides methods for fabricating chemically-tailored microscale-to-nanoscale structures, and microscale-to-nanoscale devices, comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the chemical composition of the biologically-derived microscale-to-nanoscale template is selected from the group consisting of iron oxides, titanium oxides, iron titanium oxides, manganese oxides, silicon oxide, calcium carbonates, calcium magnesium carbonates, calcium phosphates, iron calcium phosphates, calcium halides, calcium oxalate, magnesium oxalate, calcium citrates, zinc sulfides, calcium sulfates, strontium sulfates, and barium sulfates.

The present invention provides methods for fabricating chemically-tailored microscale-to-nanoscale structures, and microscale-to-nanoscale devices, comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the chemical composition of the biologically-derived microscale-to-nanoscale template is selected from the group consisting of calcite, aragonite, vaterite, monohydrocalcite, protodolomite, amorphous carbonates, amorphous hydrous carbonates, dahllite, francolite, huntite, brushite, octocalcium phosphate, calcium pyrophosphate, hydroxyapatite, calcium magnesium phosphates, whitlockite, amorphous dahllite precursor, amorphous brushite precursor, amorphous whitlockite precursor, amorphous hydrated ferric phosphate, amorphous iron calcium phosphate, fluorite, amorphous fluorite precursor, whewellite, weddelite, glushinskite, calcium citrate, gypsum, celestite, barite, opal, magnetite, maghemite, goethite, lepidocrocite, ferrihydrite, amorphous ferrihydrites, ilmenite, amorphous ilmenite, todorokite, bimessite, pyrite, hydrotroilite, sphalerite, wurtzite, and galena.

The present invention provides chemically-tailored microscale-to-nanoscale structures, and microscale-to-nanoscale devices, that are produced by the process comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the biologically-derived microscale-to-nanoscale template is comprised of a material selected from the group consisting of a solid metal, a solid metal alloy, a solid metal mixture, a solid ceramic, a solid ceramic alloy, a solid ceramic mixture, a solid organic material, a solid organic alloy, a solid organic mixture, or combinations thereof. It will be understood by those of ordinary skill in the art that the precipitation of one or more solids may occur onto the biological agent before or after attaching the biological agent to the template.

The present invention provides chemically-tailored microscale-to-nanoscale structures, and microscale-to-nanoscale devices, that are produced by the process comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the chemical composition of the said template is selected from the group consisting of oxides, carbonates, phosphates, oxalates, citrates, halides, sulfides, and sulfates.

The present invention provides chemically-tailored microscale-to-nanoscale structures, and microscale-to-nanoscale devices, that are produced by the process comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the chemical composition of the biologically-derived microscale-to-nanoscale template is selected from the group consisting of iron oxides, titanium oxides, iron titanium oxides, manganese oxides, silicon oxide, calcium carbonates, calcium magnesium carbonates, calcium phosphates, iron calcium phosphates, calcium halides, calcium oxalate, magnesium oxalate, calcium citrates, zinc sulfides, calcium sulfates, strontium sulfates, and barium sulfates.

The present invention provides chemically-tailored microscale-to-nanoscale structures, and microscale-to-nanoscale devices, that are produced by the process comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein the chemical composition of the biologically-derived microscale-to-nanoscale template is selected from the group consisting of calcite, aragonite, vaterite, monohydrocalcite, protodolomite, amorphous carbonates, amorphous hydrous carbonates, dahllite, francolite, huntite, brushite, octocalcium phosphate, calcium pyrophosphate, hydroxyapatite, calcium magnesium phosphates, whitlockite, amorphous dahllite precursor, amorphous brushite precursor, amorphous whitlockite precursor, amorphous hydrated ferric phosphate, amorphous iron calcium phosphate, fluorite, amorphous fluorite precursor, whewellite, weddelite, glushinskite, calcium citrate, gypsum, celestite, barite, opal, magnetite, maghemite, goethite, lepidocrocite, ferrihydrite, amorphous ferrihydrites, ilmenite, amorphous ilmenite, todorokite, birnessite, pyrite, hydrotroilite, sphalerite, wurtzite, and galena.

Synthetic Chemical Alteration of Biologically-Derived Templates

The present invention also provides a method further comprising the step of partially or completely altering the chemistry of the biologically-derived microscale-to-nanoscale template by conducting a chemical reaction with the said template prior to the step of attaching one or more precipitation-inducing biological agents to the template.

The present invention also provides a method further comprising the step of partially or completely altering the chemistry of the biologically-derived microscale-to-nanoscale template by conducting one or more chemical reactions with one or more reactants selected from the group consisting of a reactant present as a gas, a reactant present as a liquid, a reactant present as a solid, a reactant present in a gas phase, a reactant present in a liquid phase, a reactant present in a solid phase, or combinations thereof prior to the step of attaching one or more precipitation-inducing biological agents to the template.

The present invention also provides microscale-to-nanoscale structures, and microscale-to-nanoscale devices, that are produced by a process that includes a method further comprising the step of partially or completely altering the chemistry of the biologically-derived microscale-to-nanoscale template by conducting a chemical reaction with the said template prior to the step of attaching one or more precipitation-inducing biological agents to the template.

The present invention also provides microscale-to-nanoscale structures, and microscale-to-nanoscale devices, that are produced by a process that includes a method further comprising the step of partially or completely altering the chemistry of the biologically-derived microscale-to-nanoscale template by conducting one or more chemical reactions with one or more reactants selected from the group consisting of a reactant present as a gas, a reactant present as a liquid, a reactant present as a solid, a reactant present in a gas phase, a reactant present in a liquid phase, a reactant present in a solid phase, or combinations thereof prior to the step of attaching one or more precipitation-inducing biological agents to the template.

The present invention also provides a method further comprising the step of partially or completely altering the chemistry of the biologically-derived microscale-to-nanoscale template by conducting a chemical reaction selected from the group consisting of an oxidation-reduction reaction of the following type:
yA+aMₓN_{z}=>yAN_{za/y}+axM (3)
where A is a reactant, MₓN_{z} is a chemical constituent of the said biologically-derived microscale-to-nanoscale template, AN_{za/y} is a solid reaction product that is a solid compound, a solid solution, or a solid mixture, M is a second reaction product, and wherein y, a, x, z, za/y, and ax are stoichiometric coefficients; a metathetic reaction of the following type:
aA_{b}Y_{c}+M_{d}Xₑ=>aA_{b}X_{e/a}+M_{d}Y_{ca} (4)
where A_{b}Y_{c} is a reactant, M_{d}Xₑ is a chemical constituent of the said biologically-derived microscale-to-nanoscale template, A_{b}X_{e/a} is a solid reaction product that is a solid compound, a solid solution, or a solid mixture, M is a second reaction product, and wherein a, b, c, d, e, e/a, and ca are stoichiometric coefficients; and an additive reaction of the following type:
aA_{b}Y_{c}+M_{d}Xₑ=>aA_{b}Y_{c}M_{d}X_{c} (5)
where A_{b}Y_{c} is a reactant, M_{d}Xₑ is a chemical constituent of the said biologically-derived microscale-to-nanoscale template, A_{b}Y_{c}M_{d}Xₑ is a solid reaction product that is a solid compound, a solid solution, or a solid mixture prior to the step of attaching one or more precipitation-inducing biological agents to the template.

The present invention also provides microscale-to-nanoscale structures, and microscale-to-nanoscale devices, wherein the chemical alteration of the biologically-derived microscale-to-nanoscale template is conducted by a chemical reaction selected from the group consisting of an oxidation-reduction reaction of the following type:
yA+aMₓN_{z}=>yAN_{za/y}+axM (6)
where A is a reactant, MₓN_{z} is a chemical constituent of the said biologically-derived microscale-to-nanoscale template, AN_{za/y} is a solid reaction product that is a solid compound, a solid solution, or a solid mixture, M is a second reaction product, and wherein y, a, x, z, za/y, and ax are stoichiometric coefficients; a metathetic reaction of the following type:
aA_{b}Y_{c}+M_{d}Xₑ=>aA_{b}X_{e/a}+M_{d}Y_{ca} (7)
where A_{b}Y_{c} is a reactant, M_{d}Xₑ is a chemical constituent of the said biologically-derived microscale-to-nanoscale template, A_{b}X_{e/a} is a solid reaction product that is a solid compound, a solid solution, or a solid mixture, M is a second reaction product, and wherein a, b, c, d, e, e/a, and ca are stoichiometric coefficients; and an additive reaction of the following type:
aA_{b}Y_{c}+M_{d}Xₑ=>aA_{b}Y_{c}M_{d}Xₑ (8)
where A_{b}Y_{c} is a reactant, M_{d}Xₑ is a chemical constituent of the said biologically-derived microscale-to-nanoscale template, A_{b}Y_{c}M_{d}Xₑ is a solid reaction product that is a solid compound, a solid solution, or a solid mixture prior to the step of attaching one or more precipitation-inducing biological agents to the template.

The present invention also provides a method further comprising the step of altering the chemistry of the biologically-derived microscale-to-nanoscale template by applying a synthetically-derived coating to the said template prior to the step of attaching one or more precipitation-inducing biological agents to the said template.

The present invention also provides microscale-to-nanoscale structures, and microscale-to-nanoscale devices, wherein the chemical alteration of the biologically-derived microscale-to-nanoscale template is conducted by applying a synthetically-derived coating to the said template prior to the step of attaching one or more precipitation-inducing biological agents to the said template.

The present invention also provides a method further comprising the step of altering the chemistry of the biologically-derived microscale-to-nanoscale template by applying a synthetically-derived coating to the said template prior to the step of attaching one or more precipitation-inducing biological agents to the said template, wherein the said synthetically-derived coating is applied by exposure of the biologically-derived template to the group consisting of a gas phase, a liquid phase, a solid phase, or some combination thereof.

The present invention also provides microscale-to-nanoscale structures, and microscale-to-nanoscale devices, wherein the chemical alteration of the biologically-derived microscale-to-nanoscale template is conducted by applying a synthetically-derived coating to the said template, prior to the step of attaching one or more precipitation-inducing biological agents to the said template, by exposure of the biologically-derived template to the group consisting of a gas phase, a liquid phase, a solid phase, or some combination thereof.

The synthetically-derived coating may be applied to the biologically-derived microscale-to-nanoscale template by physical vapor deposition, chemical vapor deposition, or some combination thereof. The synthetically-derived coating may be applied to the biologically-derived microscale-to-nanoscale template by a process selected from the group consisting of, but not limited to, sol-gel processing, hydrothermal processing, polymer precursor processing, dip coating in a liquid solution, dip coating in a mixture of solid particles in a liquid solution, direct writing from a fine solid tip coated with a liquid solution, or direct writing from a fine solid tip coated with a mixture of solid particles in a liquid solution.

The present invention provides a method wherein said partial or complete chemical alteration of the biologically-derived microscale-to-nanoscale template is conducted under conditions that do not cause distortion of the said template. The present invention provides a method wherein said partial or complete chemical alteration of the biologically-derived microscale-to-nanoscale template is achieved with a chemical reaction that is conducted under conditions that do not cause distortion of the said template. The present invention provides a method wherein said chemical alteration of the biologically-derived microscale-to-nanoscale template is conducted by applying or forming a synthetically-derived coating on the biologically-derived microscale-to-nanoscale template under conditions that do not cause distortion of the said template.

The present invention also provides microscale-to-nanoscale structures, and microscale-to-nanoscale devices, wherein the chemical alteration of the biologically-derived microscale-to-nanoscale template is conducted under conditions that do not cause distortion of the said template. The present invention also provides microscale-to-nanoscale structures, and microscale-to-nanoscale devices, wherein the said partial or complete chemical alteration of the biologically-derived microscale-to-nanoscale template is achieved with a chemical reaction that is conducted under conditions that do not cause distortion of the said template. The present invention provides also provides microscale-to-nanoscale structures, and microscale-to-nanoscale devices, wherein said chemical alteration of the biologically-derived microscale-to-nanoscale template is conducted by applying or forming a synthetically-derived coating on the biologically-derived microscale-to-nanoscale template under conditions that do not cause distortion of the said template.

Precipitation-Inducing Biological Agents

The present invention provides methods for fabricating chemically-tailored microscale-to-nanoscale structures, and microscale-to-nanoscale devices, comprising the steps of: i) obtaining one or more biologically-derived microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the template, wherein said biological agent is a native or modified biological organism, or a portion of a native or modified biological organism, or a native or modified biological molecule, or a portion of a native or modified biological molecule. The biological organism or biological molecule may be modified through environmental changes or chemical changes or genetic changes.

As used herein “precipitation-inducing” biological agent refers to a biological agent that enables a desired solid, solid solution, or solid mixture to form from a precursor or precursor solution or that enhances the rate of formation of a desired solid, solid solution, or solid mixture from a precursor or precursor solution. The said biological agent is selected from the group consisting of, but not limited to, a cell or cells, one or more organelles within a cell or cells, nucleotides, proteins, polypeptides, polyamines, polysaccharides, and combinations thereof. It is understood by those of ordinary skill in the art that a biological agent may also be synthetically produced. In will be further understood by those of ordinary skill in the art that the precipitation of one or more solids may occur onto the biological agent before or after attaching the biological agent to the template.

The present invention provides microscale-to-nanoscale structures, and microscale-to-nanoscale devices, that are produced by the process comprising the steps of: i) obtaining one or more biologically-derived microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the template, wherein said biological agent is a native or modified biological organism, or a portion of a native or modified biological organism, or a native or modified biological molecule, or a portion of a native or modified biological molecule.

Methods for Attaching Precipitation-Inducing Biological Agents to Biologically-Derived Templates

The present invention provides methods for fabricating chemically-tailored microscale-to-nanoscale structures, and microscale-to-nanoscale devices, comprising the steps of: i) obtaining one or more biologically-derived microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the template, wherein said biological agents are attached to the said templates through covalent bonding or ionic bonding or Van der Waals bonding, or combinations thereof. It will be understood by those of ordinary skill in the art that the precipitation of one or more solids may occur onto the biological agent before or after attaching the biological agent to the template.

The present invention provides microscale-to-nanoscale structures, and microscale-to-nanoscale devices, that are produced by the process comprising the steps of: i) obtaining one or more biologically-derived microscale-to-nanoscale templates of the desired shape and with desired fine features, ii) attaching one or more precipitation-inducing biological agents to the one or more microscale-to-nanoscale templates, and iii) exposing the one or more biological agents on the one or more templates to one or more precursors or precursor-bearing solutions so as to induce the precipitation of one or more desired solids onto the template, wherein said biological agents are attached to the said templates through covalent bonding or ionic bonding or Van der Waals bonding, or combinations thereof.

The surface of the biologically-derived templates may be chemically modified to promote bonding of the precipitation-inducing biological agents. Such modification may include, but is not limited to, changing the surface chemistry of the biologically-derived template to effect the hydrophilicity or hydrophobicity of the biologically-derived template, silanization of the surface of the biologically-derived template, and/or attachment of cross-linker agents to the surface of the biologically-derived template. Examples of changes in the surface chemistry that effect the hydrophilicity or hydrophobicity include, but are not limited to, hydration or dehydration, and coating or doping with another material that possesses enhanced hydrophilicity or hydrophobicity. Covalent bonding of the precipitation-inducing biological agent may be aided by procedures, such as silanization procedures, that yield surfaces of the biologically-derived template that are terminated with groups that include, but are not limited to, amine, thiol, ethylamino, or epoxy groups. Chemicals used for such silanization procedures may include, but are not limited to, 3-aminopropyltrimethoxysilane, 3-aminopropyltriethoxysilane, 3-mercaptotrimethoxysilane, 3-mercaptopropyltriethoxysilane, 3-[2-(2-aminoethylamino)ethylamino]propyl-trimethoxysilane, [3-(2-aminoethylamino)propyl]trimethoxysilane, 2-(3,4-epoxycyclohexyl)ethyl-trimethoxysilane, 3-[Bis(2-hydroxyethyl)amino]propyl-triethoxysilane, or 3-glycidyloxypropyl)triethoxysilane. Biological molecules may be sequestered to the biological template surface through reactions with cross-linking agents attached to the native or modified surface of the biological template. These cross-linking agents may covalently bond to biological molecules through reactions with the sulfhydryl, carboxyl, or amine groups of the biological molecules. An example of such a cross-linking reaction includes the bonding of a sulfhydryl group of a biological molecule through reaction with the maleimide group of a chemical such as N-[p-Maleimidophenyl]isocyanate that is attached to a hydroxyl-terminated biological template surface. Another example of such a cross-linking reaction includes the bonding of a sulfhydryl group of a biological molecule through reaction with the maleimide group of N-ε-Maleimidocaproic acid that is linked to an amine-terminated biological template surface through reaction with 1-ethyl-3-[3-dimethylaminopropyl]carbodiimide hydrochloride. Yet another example of such a cross-linking reaction includes the bonding of a hydroxyl group of a biological molecule to a thiol-terminated biological surface through conversion of the hydroxyl group to an active aldehyde by reaction with sodium metaperiodate which can then react with the hydrazide group on thiol surface-bound 4 (4-N-maleimidophenyl)butyric acid hydrazide hydrochloride molecules to form hydrazones.

The present invention provides methods for fabricating chemically-tailored microscale-to-nanoscale structures, and microscale-to-nanoscale devices, comprising the steps of: i) obtaining one or more biologically-derived microscale-to-nanoscale templates of the desired shape and with desired fine features, ii) localizing one or more precipitation-inducing biological agents to one or more surfaces of the one or more microscale-to-nanoscale templates, and iii) exposing the one or more biological agents on the one or more templates to one or more precursors or precursor-bearing solutions so as to induce the precipitation of one or more desired solids onto the template, wherein said biological agents are localized to the one or more surfaces of said templates through incorporation within a coating applied to the biologically-derived template.

The present invention provides microscale-to-nanoscale structures, and microscale-to-nanoscale devices, that are produced by the process comprising the steps of: i) obtaining one or more biologically-derived microscale-to-nanoscale templates of the desired shape and with desired fine features, ii) localizing one or more precipitation-inducing biological agents to one or more surfaces of the one or more microscale-to-nanoscale templates, and iii) exposing the one or more biological agents on the one or more templates to one or more precursors or precursor-bearing solutions so as to induce the precipitation of one or more desired solids onto the template, wherein said biological agents are localized to the one or more surfaces of said templates through incorporation within a coating applied to the biologically-derived template.

Precipitation-inducing biological agents may be incorporated into a coating applied to the biologically-derived template surface, wherein said coating is comprised of the group including, but not limited to, an organic material, a mixture of organic materials, a ceramic material, a mixture of ceramic materials, a metallic material, a mixture of metallic materials, a semiconductor material, or combinations thereof. Examples of said organic materials include epoxies or acrylic resins.

Shape and Feature Preservation after Biologically-Induced Precipitation

The present invention provides methods for fabricating chemically-tailored microscale-to-nanoscale structures, and microscale-to-nanoscale devices, comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein said precipitation is carried out under conditions that do not cause distortion of the biologically-derived microscale-to-nanoscale template.

The present invention provides microscale-to-nanoscale structures, and microscale-to-nanoscale devices, that are produced by the process comprising the steps of: i) obtaining a biologically-derived microscale-to-nanoscale template of the desired shape and with desired fine features, ii) attaching one or more precipitation-inducing biological agents to the microscale-to-nanoscale template, and iii) exposing the one or more biological agents on the template to one or more precursors or precursor-bearing solutions so as to induce the precipitation of one or more desired solids onto the template, wherein said precipitation is carried out under conditions that do not cause distortion of the biologically-derived microscale-to-nanoscale template.

The present invention also provides methods for fabricating microscale-to-nanoscale structures, and microscale-to-nanoscale devices, containing solid material that has been precipitated through the use of a biological agent onto a biologically-derived microscale-to-nanoscale template wherein said structures and devices have substantially the same size and dimensional features as the said template. The method may be performed at temperatures of 200° C. or less. In preferred embodiments, the method may be performed at temperatures of 100′ C or less.

The present invention also provides microscale-to-nanoscale structures, and microscale-to-nanoscale devices, containing solid material that has been precipitated through the use of a biological agent onto a biologically-derived microscale-to-nanoscale template wherein said structures and devices have substantially the same size and dimensional features as the said template. In some embodiments, the solid material may be an amalgam of active and inactive material. For example, the active material may be a protein, such as an enzyme, encapsulated by the inactive material.

Synthetic Chemical Alterations of Biologically-Induced Precipitates

The present invention also provides a method further comprising the step of partially or completely altering the chemistry of one or more biologically-induced precipitates on the biologically-derived microscale-to-nanoscale template.

The present invention also provides a method further comprising the step of partially or completely altering the chemistry of one or more biologically-induced precipitates on the biologically-derived microscale-to-nanoscale template by using a chemical reaction.

The present invention also provides a method further comprising the step of partially or completely altering the chemistry of one or more biologically-induced precipitates on the biologically-derived microscale-to-nanoscale template by reactive conversion wherein said reactive conversion is conducted by one or more chemical reactions with one or more reactants selected from the group consisting of a reactant present as a gas, a reactant present as a liquid, a reactant present as a solid, a reactant present in a gas phase, a reactant present in a liquid phase, a reactant present in a solid phase, or combinations thereof.

The present invention also provides microscale-to-nanoscale structures, and microscale-to-nanoscale devices, that are produced by a process that includes a method further comprising the step of partially or completely altering the chemistry of one or more biologically-induced precipitates on the biologically-derived microscale-to-nanoscale template.

The present invention also provides microscale-to-nanoscale structures, and microscale-to-nanoscale devices, that are produced by a process that includes a method further comprising the step of partially or completely altering the chemistry of one or more biologically-induced precipitates on the biologically-derived microscale-to-nanoscale template by using a chemical reaction.

The present invention also provides microscale-to-nanoscale structures, and microscale-to-nanoscale devices, that are produced by a process that includes a method further comprising the step of partially or completely altering the chemistry of one or more biologically-induced precipitates on the biologically-derived microscale-to-nanoscale template by reactive conversion wherein said reactive conversion is conducted by one or more chemical reactions with one or more reactants selected from the group consisting of a reactant present as a gas, a reactant present as a liquid, a reactant present as a solid, a reactant present in a gas phase, a reactant present in a liquid phase, a reactant present in a solid phase, or combinations thereof.

The present invention also provides a method further comprising the step of partially or completely altering the chemistry of one or more biologically-induced precipitates on the biologically-derived microscale-to-nanoscale template by using a chemical reaction selected from the group consisting of an oxidation-reduction reaction of the following type:
yA+aMₓN_{z}=>yAN_{za/y}+axM (9)
where A is a reactant, MₓN_{z} is a chemical constituent of the said biologically-induced precipitate, AN_{za/y} is a solid reaction product that is a solid compound, a solid solution, or a solid mixture, M is a second reaction product, and wherein y, a, x, z, za/y, and ax are stoichiometric coefficients; a metathetic reaction of the following type:
aA_{b}Y_{c}+M_{d}Xₑ=>aA_{b}X_{c/a}+M_{d}Y_{ca} (10)
where A_{b}Y_{c} is a reactant, M_{d}Xₑ is a chemical constituent of the said biologically-induced precipitate, A_{b}X_{e/a} is a solid reaction product that is a solid compound, a solid solution, or a solid mixture, M is a second reaction product, and wherein a, b, c, d, e, e/a, and ca are stoichiometric coefficients; and an additive reaction of the following type:
aA_{b}Y_{c}+M_{d}Xₑ=>aA_{b}Y_{c}M_{d}Xₑ (11)
where A_{b}Y_{c} is a reactant, M_{d}Xₑ is a chemical constituent of the said biologically-induced precipitate, A_{b}Y_{c}M_{d}Xₑ is a solid reaction product that is a solid compound, a solid solution, or a solid mixture.

The present invention also provides microscale-to-nanoscale structures, and microscale-to-nanoscale devices, wherein the chemical alteration of the one or more biologically-induced precipitates on the biologically-derived microscale-to-nanoscale template is conducted by using a chemical reaction selected from the group consisting of an oxidation-reduction reaction of the following type:
yA+aMₓN_{z}=>yAN_{za/y}+axM (12)
where A is a reactant, MₓN_{y} is a chemical constituent of the said biologically-induced precipitate, AN_{za/y} is a solid reaction product that is a solid compound, a solid solution, or a solid mixture, M is a second reaction product, and wherein y, a, x, z, za/y, and ax are stoichiometric coefficients; a metathetic reaction of the following type:
aA_{b}Y_{c}+M_{d}Xₑ=>aA_{b}X_{e/a}+M_{d}Y_{ca} (13)
where A_{b}Y_{c} is a reactant, M_{d}Xₑ is a chemical constituent of the said biologically-induced precipitate, A_{b}X_{e/a} is a solid reaction product that is a solid compound, a solid solution, or a solid mixture, M is a second reaction product, and wherein a, b, c, d, e, e/a, and ca are stoichiometric coefficients; and an additive reaction of the following type:
aA_{b}Y_{c}+M_{d}Xₑ=>aA_{b}Y_{c}M_{d}Xₑ (14)
where A_{b}Y_{c} is a reactant, M_{d}Xₑ is a chemical constituent of the said biologically-induced precipitate, A_{b}Y_{c}M_{d}Xₑ is a solid reaction product that is a solid compound, a solid solution, or a solid mixture.

The present invention also provides a method further comprising the step of altering the chemistry of one or more biologically-induced precipitates on the biologically-derived microscale-to-nanoscale template by applying a synthetically-derived coating to the one or more said precipitates.

The present invention also provides a method further comprising the step of altering the chemistry of one or more biologically-induced precipitates on the biologically-derived microscale-to-nanoscale template by applying a synthetically-derived coating to the one or more said precipitates, wherein the said synthetically-derived coating is applied by exposure of the one or more biologically-induced precipitates to one or more precursors present in the group consisting of a gas phase, a liquid phase, a solid phase, or some combination thereof.

The present invention also provides microscale-to-nanoscale structures, and microscale-to-nanoscale devices, wherein the chemical alteration of the one or more biologically-induced precipitates on the biologically-derived microscale-to-nanoscale template is conducted by applying a synthetically-derived coating to the one or more said precipitates.

The present invention also provides microscale-to-nanoscale structures, and microscale-to-nanoscale devices, wherein the chemical alteration of the one or more biologically-induced precipitates on the biologically-derived microscale-to-nanoscale template is conducted by exposure of the one or more biologically-induced precipitates to one or more precursors present in the group consisting of a gas phase, a liquid phase, a solid phase, or some combination thereof.

The synthetically-derived coating may be applied to the biologically-induced precipitates by physical vapor deposition, chemical vapor deposition, or some combination thereof. The synthetically-derived coating may be applied to the biologically-induced precipitates by a process selected from the group consisting of, but not limited to, sol-gel processing, hydrothermal processing, polymer precursor processing, dip coating in a liquid solution, dip coating in a mixture of solid particles in a liquid solution, direct writing from a fine solid tip coated with a liquid solution, or direct writing from a fine solid tip coated with a mixture of solid particles in a liquid solution.

The present invention provides a method wherein said partial or complete chemical alteration of the one or more biologically-induced precipitates on the biologically-derived microscale-to-nanoscale template is conducted under conditions that do not cause distortion of the said template. The present invention provides a method wherein said partial or complete chemical alteration of the one or more biologically-induced precipitates on the biologically-derived microscale-to-nanoscale template is achieved with a chemical reaction that is conducted under conditions that do not cause distortion of the said template. The present invention provides a method wherein said chemical alteration of the one or more biologically-induced precipitates on the biologically-derived microscale-to-nanoscale template is conducted by applying or forming a synthetically-derived coating on the one or more said biologically-induced precipitates under conditions that do not cause distortion of the said template.

The present invention provides microscale-to-nanoscale structures, and microscale-to-nanoscale devices, wherein the chemical alteration of the one or more biologically-induced precipitates on the biologically-derived microscale-to-nanoscale template is conducted under conditions that do not cause distortion of the said template. The present invention provides microscale-to-nanoscale structures, and microscale-to-nanoscale devices, wherein the said partial or complete chemical alteration of the one or more biologically-induced precipitates on the biologically-derived microscale-to-nanoscale template is achieved with a chemical reaction that is conducted under conditions that do not cause distortion of the said template. The present invention provides microscale-to-nanoscale structures, and microscale-to-nanoscale devices, wherein the said chemical alteration of the one or more biologically-induced precipitates on the biologically-derived microscale-to-nanoscale template is conducted by applying or forming a synthetically-derived coating on the one or more said biologically-induced precipitates under conditions that do not cause distortion of the said template.

Template Removal

The present invention also provides a method further comprising the step of partially or completely removing the biologically-derived microscale-to-nanoscale template after biologically-induced precipitation of one or more desired solids onto the said template.

The present invention also provides microscale-to-nanoscale structures, and microscale-to-nanoscale devices, wherein the biologically-derived microscale-to-nanoscale template is partially or completely removed after biologically-induced precipitation of one or more desired solids onto the said template.

The present invention also provides a method further comprising the step of partially or completely removing the biologically-derived microscale-to-nanoscale template after altering the chemistry of the said template. The present invention also provides a method further comprising the step of partially or completely removing the biologically-derived microscale-to-nanoscale template after altering the chemistry of the said template by reactive chemical conversion. The present invention also provides a method further comprising the step of partially or completely removing the biologically-derived microscale-to-nanoscale template after altering the chemistry of the said template by applying a synthetically-derived coating.

The present invention also provides microscale-to-nanoscale structures, and microscale-to-nanoscale devices, wherein the biologically-derived microscale-to-nanoscale template is partially or completely removed after altering the chemistry of the said template. The present invention also provides microscale-to-nanoscale structures, and microscale-to-nanoscale devices, wherein the biologically-derived microscale-to-nanoscale template is partially or completely removed after altering the chemistry of the said template by reactive chemical conversion. The present invention also provides microscale-to-nanoscale structures, and microscale-to-nanoscale devices, wherein the biologically-derived microscale-to-nanoscale template is partially or completely removed after altering the chemistry of the said template by applying a synthetically-derived coating.

The present invention also provides a method further comprising the step of partially or completely removing the biologically-derived microscale-to-nanoscale template after altering the chemistry of one or more biologically-induced precipitates on the template. The present invention also provides a method further comprising the step of partially or completely removing the biologically-derived microscale-to-nanoscale template after altering the chemistry of one or more biologically-induced precipitates on the template by reactive chemical conversion. The present invention also provides a method further comprising the step of partially or completely removing the biologically-derived microscale-to-nanoscale template after altering the chemistry of one or more biologically-induced precipitates on the template by applying a synthetically-derived coating.

The present invention also provides microscale-to-nanoscale structures, and microscale-to-nanoscale devices, wherein the biologically-derived microscale-to-nanoscale template is partially or completely removed after altering the chemistry of one or more biologically-induced precipitates on the template. The present invention also provides microscale-to-nanoscale structures, and microscale-to-nanoscale devices, wherein the biologically-derived microscale-to-nanoscale template is partially or completely removed after altering the chemistry of one or more biologically-induced precipitates on the template by reactive chemical conversion. The present invention also provides microscale-to-nanoscale structures, and microscale-to-nanoscale devices, wherein the biologically-derived microscale-to-nanoscale template is partially or completely removed after altering the chemistry of one or more biologically-induced precipitates on the template by applying a synthetically-derived coating.

The partial or complete removal of the biologically-derived microscale-to-nanoscale template may be conducted by a process selected from the group consisting of, but not limited to, selective dissolution of the template, selective evaporation of the template, selective melting of the template, selective reaction of the template, selective disintegration of the template, or combinations thereof. The term “selective” refers to removal of the original biologically-derived template with little or no removal of the biologically-induced precipitates formed on the template, the chemically-modified template, or both.

### EXAMPLES OF THE INVENTION

### Example 1

A chimeric peptide was used as a biomineralizing agent to generate germania on the surfaces of natural, silica-based 3-D microshells of diatoms (a type of aquatic algae). A chimeric peptide was prepared by the fusion of two peptide molecules, each of which was used for a different function (hence the label “chimeric” peptide). One of these two peptides (part of the chimeric molecule) was selected to bind to the silica-based diatom microshells. The other peptide (other part of the chimeric molecule) was utilized to promote the local formation of germania.

To demonstrate this approach, a silica-binding polylysine molecule (a peptide comprised of 4 lysine residues) was fused to a germania-forming peptide. The germania-forming peptide possessed the amino acid sequence: SLKMPHWPHLLP. This peptide was isolated and identified with the use of a phage display combinatorial method (M13 bacteriophage surface display library, New England BioLabs). The two peptides were linked together with 3 glycine amino acid residues. Hence, the chimeric peptide sequence was: SLKMPHWPHLLPGGGKKKK.

3 milligrams of hydrolyzed Aulacoseira diatom microshells were exposed for 2 hours with rotation (25 rpm) to a mixture comprised of 1 milliliter of a buffer (tris-buffered saline) with 20 microliters of a chimeric peptide solution. The latter chimeric peptide solution was prepared with a concentration of 10 milligrams of the peptide per milliliter of de-ionized water. The microshells were then condensed by centrifugation. The buffer/peptide mixture was then eluted from the microshells. The microshells were then washed 5 times with the tris-buffered saline solution. The microshells were then re-centrifuged, and the saline solution was poured off. 100 microliters of methanol were then added to the microshells. 100 microliters of a 4 vol % solution of TMOG (tetramethoxygermanium) in methanol was then added to the mixture of diatom microshells and methanol. After 30 minutes, the microshells were centrifuged, and the solution was decanted away. The microshells were then washed 5 times with methanol.

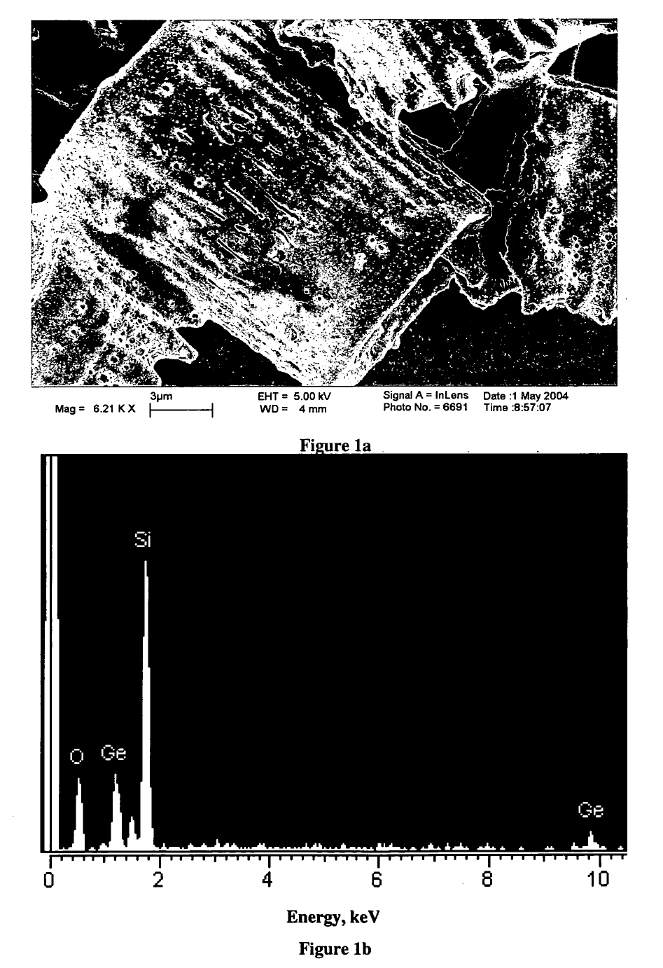

A secondary electron image of the resulting diatom microshells is shown in FIG. 1a. An energy-dispersive x-ray (EDX) pattern obtained from such treated microshells is shown in FIG. 1b. In addition to peaks for silicon and oxygen (generated by the underlying SiO₂-based diatom microshell template), distinct peaks for germanium can be seen in the EDX pattern in FIG. 1b. This demonstrates that germanium formation had been induced on the diatom microshell surfaces through the action of the chimeric peptide (i.e., germanium was not present in the starting silica-based diatom microshell template).

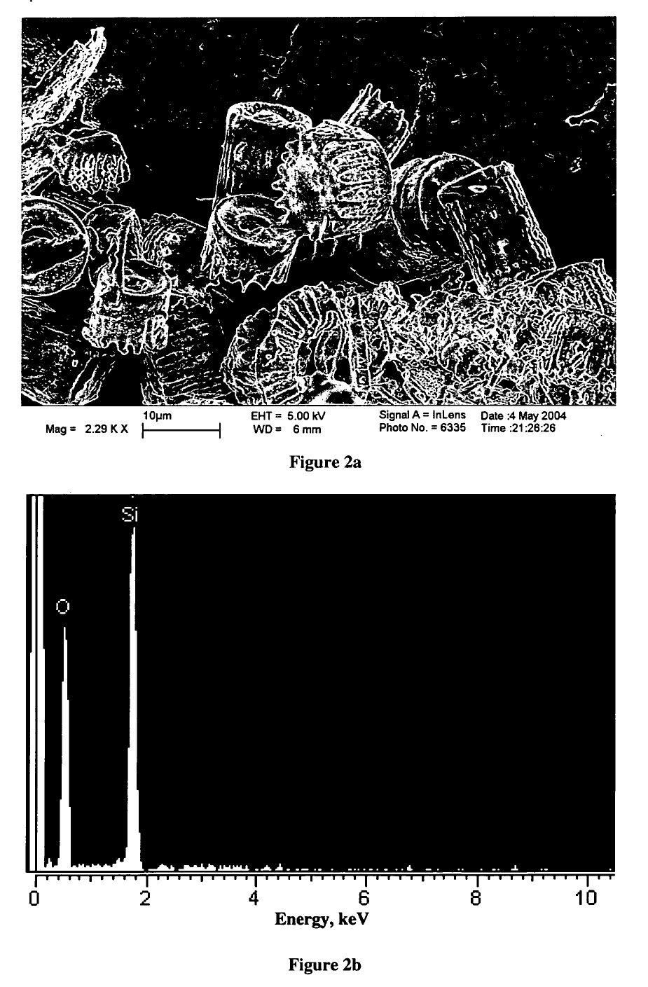

In order to confirm that the germania formation indicated in FIG. 1b resulted specifically from the presence of the chimeric peptide attached to the diatom microshell surface, a “control” experiment was conducted. The control experiment was conducted in a similar manner as described above, except that the microshells were exposed initially to a mixture of the buffer (tris-buffered saline) with an equivalent volume of water, instead of the chimeric peptide. A secondary electron image of the resulting diatom microshells is shown in FIG. 2a. An energy-dispersive x-ray (EDX) pattern obtained from such treated microshells is shown in FIG. 2b. The diatom microshell templates exposed to this control treatment did not exhibit peaks for germanium by EDX analysis. Hence, the chimeric peptide clearly acted to promote the formation of germanium oxide on the diatom microshell surfaces.

### Example 2

In this example, a peptide that promotes the formation of germania is covalently bonded to a silica-based diatom microshell. Such covalent bonding is conducted by reaction of the peptide with a glutaraldehyde group attached to a silane coating applied to the diatom microshell.

In this process, hydrolyzed surfaces of diatom microshells are exposed to γ-aminopropyltriethoxysilane for 0.5 hours at room temperature in order to coat the silica surfaces with a silane layer. The exposed amine group in this silane layer is then bound to glutaraldehyde with a 1 hour exposure at room temperature. The exposed C═O group on the glutaraldehyde is then available to form a covalent bond to the desired peptide. A germanium-binding peptide (Ge8 peptide, SLKMPHWPHLLPGGGKKKK, recently identified by Dickerson, et al., Chem. Comm., 15, 1776-1777 (2004)) is then exposed to the silanized silica surface for 3 hours at room temperature. The treated surface is then exposed for 15 minutes to a germanium-bearing precursor solution (0.135 M tetramethoxygermanium, TMOG, dissolved in methanol) at room temperature, to allow for the formation of germanium oxide on the diatom microshell surfaces.

### Example 3

In this example, a peptide that promotes the formation of germania is covalently bonded to a silica-based diatom microshell. Such covalent bonding is conducted by reaction of the peptide with a maleimide group (from a sulfo-SMCC molecule) attached to a silane coating present on a Hyalodiscus stelliger diatom microshell (frustule).

In this process, aqua cultured Hyalodiscus stelliger diatom frustules were cleaned by boiling in concentrated nitric, sulfuric, and fuming nitric acids, rinsing with copious amounts of high purity (18.2 MΩ) water, followed by exposure to an ammonium hydroxide and hydrogen peroxide solution at 75° C. for 15 minutes and additional rinsing with 18.2 MΩ water. The cleaned diatom silica microshells were then coated with an amine-terminated silane layer by exposing the microshells (10 mg) to 1 ml of a 2 vol % γ-aminopropyltriethoxysilane solution in dry acetone for 5 minutes with stirring (30 rpm rotation) at room temperature. The diatom frustules were then collected via centrifugation at 14,000 rpm for 1 minute and subsequently rinsed 5 times with 1 ml of dry acetone (note: after each of these 5 rinsing steps, the diatoms were collected via centrifugation and the rinse solution was removed). The silanized 10 mg diatom frustule sample was then allowed to air dry for 30 minutes in a chemical safety fume hood.

The exposed amine group present on this silane coating was then bound to the N-hydroxysuccinimide ester of sulfo-SMCC (Sulfosuccinimidyl-4-(N-maleimidomethyl)cyclohexane-1-carboxylate), which is a heterofunctional cross linking reagent. This was accomplished by incubating the amine-modified diatom frustules with a solution of 2 mg of sulfo-SMCC in 1 ml of HEPES coupling buffer (50 mM HEPES buffer, 150 mM NaCl, 10 mM EDTA, pH 7.2) for 1 hour at room temperature with stirring (30 rpm). The diatom frustules were recovered after exposure to this solution and collected by centrifugation at 14,000 rpm for 1 minute. Excess sulfo-SMCC reagent was removed from the diatom frustules by rinsing 5 times with 1 ml of HEPES coupling buffer (the diatoms were collected via centrifugation after each rinsing step and the rinse solution removed). The remaining maleimide moiety of the sulfo-SMCC molecule was then available to form a covalent bond with a sulfhydryl group of a desired peptide. In order to promote such a reaction event, a sulfhydryl group in a cysteine residue was added to the c-terminus of a silica precipitating peptide. The peptide chosen for this example (Si41c, MSPHPHP GGC) was previously determined to be cross-reactive for germania precipitation. This Si41c peptide, recently identified by Naik, et. al., (Journal of Nanoscience and Nanotechnology (2002), 2(1), 95-100), was incubated for 15 minutes in a solution of 5 mM TCEP-HCl (Tris(2-carboxyethyl)phosphine hydrochloride) in HEPES coupling buffer in order to insure that all cysteine residues were in a reduced state. A 1 ml volume of the reduced peptide, at a concentration of 0.25 mg/ml, in 5 mM TECP-HCl HEPES coupling buffer solution was then added to 5 mg of the aforementioned chemically modified diatom microshells. The diatom frustule-peptide mixture was agitated by 30 rpm rotation for 3 hours at room temperature. The diatom microshells, with peptides now covalently attached to their surfaces, were collected by centrifugation at 14,000 rpm for 1 minute. Non-bound peptide and excess reaction solution species were removed by rinsing the sample with 1 ml of HEPES coupling buffer 5 times (the diatoms were collected by centrifugation between rinsing steps). The peptide-functionalized diatom frustules were then exposed for 30 minutes to a germanium-bearing precursor solution (0.135 M tetramethoxygermanium, TMOG, dissolved in anhydrous methanol) at room temperature, to allow for the peptide-induced formation of germanium oxide on the diatom microshell surfaces. Excess TMOG reagent was removed from the diatom frustule samples by rinsing 5 times with 1 ml of anhydrous methanol, where the frustules were collected by centrifugation between rinsing steps.

Secondary electron images of the resulting diatom microshells are shown in FIGS. 1a-c. Fine (<1 micrometer diameter) particles can be seen to coat the diatom microshell surfaces. An energy-dispersive x-ray (EDX) pattern obtained from such treated microshells is shown in FIG. 1d. In addition to peaks for silicon and oxygen (generated by the underlying SiO₂-based diatom microshell template), distinct peaks for germanium can be seen in the EDX pattern in FIG. 1d. This demonstrates that germania particle formation had been induced on the diatom microshell surfaces through the action of the covalently attached Si41c peptide (i.e., germanium was not present in or on the starting silica-based diatom microshell template).

In order to confirm that the germania formation indicated in FIG. 1 resulted specifically from the presence of the peptide covalently attached to the diatom microshell surface, a “control” experiment was conducted. The control experiment was conducted in a similar manner as described above, except that the microshells were exposed to a solution of the TCEP-HCl/HEPES buffer solution with an equivalent volume of water, instead of the Si41c peptide. Secondary electron images of the resulting diatom microshells are shown in FIGS. 2a-c. The submicron particles detected in the images of FIGS. 1a-c were absent in the images of FIGS. 2a-c. An energy-dispersive x-ray (EDX) pattern obtained from such treated microshells is shown in FIG. 2d. The diatom microshell templates exposed to this control treatment did not exhibit peaks for germanium by EDX analysis. Hence, the covalent attachment of mineralizing peptides clearly acted to promote the formation of germanium oxide on the diatom microshell surfaces.

### Example 4

In this example, a peptide that promotes the formation of germania is covalently bonded to a silica-based Nitzschia alba diatom microshell. Such covalent bonding is conducted by reaction of the peptide with a maleimide group (from a SMPB molecule) attached to a silane coating applied to the diatom microshell.

In this process, aqua cultured Nitzschia alba diatoms were cleaned by boiling in concentrated nitric, sulfuric, and fuming nitric acids, rinsing with copious amounts of high purity (18.2 MΩ) water, followed by exposure to an ammonium hydroxide and hydrogen peroxide solution at 75° C. for 15 minutes and additional rinsing with 18.2 MΩ water. The cleaned diatom silica microshells were then coated with an amine-terminated silane layer by exposing the microshells (10 mg) to 1 ml of a 2 vol % γ-aminopropyltriethoxysilane solution in dry acetone for 5 minutes with stirring (30 rpm rotation) at room temperature. The diatom frustules were then collected via centrifugation at 14,000 rpm for 1 minute and subsequently rinsed 5 times with 1 ml of dry acetone (note: after each of these 5 rinsing steps, the diatoms were collected via centrifugation and the rinse solution was removed). The silanized 10 mg diatom frustule sample was then allowed to air dry for 30 minutes in a chemical safety fume hood.

The exposed amine group in this added silane layer was then bound to the N-hydroxysuccinimide ester of SMPB (Succinimidyl 4-[p-maleimidophenyl]butyrate), which is a heterofunctional cross linking reagent. This was accomplished by incubating the amine-modified diatom frustules with a solution of 3.6 mg of SMPB in a solution of 20 vol % anhydrous DMSO and 80 vol % anhydrous ethanol for 1 day at room temperature with stirring (30 rpm). The diatoms were recovered after exposure to this solution and collected by centrifugation at 14,000 rpm for 1 minute. Excess SMPB reagent was removed from the diatom frustules by rinsing 3 times with a 20% DMSO 80% ethanol solution (note: the rinse solution was removed from the diatom frustules after they were collected by centrifugation at each step). The remaining maleimide moiety of the SMPB molecule was then available to form a covalent bond with a sulfhydryl group of a desired peptide. In order to promote such a reaction event, a sulfhydryl group in a cysteine residue was added to the c-terminus of a silica precipitating peptide. The peptide chosen for this example (Si41c, MSPHPHPRHHHGGC) was previously determined to be cross-reactive for germania precipitation. This Si41c peptide, recently identified by Naik, et. al., (Journal of Nanoscience and Nanotechnology (2002), 2(1), 95-100), was incubated for 15 minutes in a solution of 5 mM TCEP-HCl (Tris(2-carboxyethyl)phosphine hydrochloride) in HEPES coupling buffer in order to insure that all cysteine residues were in a reduced state. A 1 ml volume of the reduced peptide, at a concentration of 0.25 mg/ml, in 5 mM TECP-HCl HEPES coupling buffer solution was then added to 5 mg of the aforementioned chemically modified diatom microshells. The diatom-peptide solution samples were agitated by 30 rpm rotation for 2 days at room temperature. The diatom microshells, with peptides now covalently attached to their surfaces, were collected by centrifugation at 14,000 rpm for 1 minute. Non-bound peptide and excess reaction solution species were removed by rinsing the sample with 1 ml of HEPES coupling buffer 5 times (the diatoms were collected by centrifugation between rinsing steps). The treated surface was then exposed for 30 minutes to a germanium-bearing precursor solution (0.135 M tetramethoxygermanium, TMOG, dissolved in anhydrous methanol) at room temperature, to allow for the peptide-induced formation of germanium oxide on the diatom microshell surfaces. Excess TMOG reagent was removed from the diatom samples by rinsing 5 times with 1 ml of anhydrous methanol, where the diatoms were collected by centrifugation between rinsing steps.

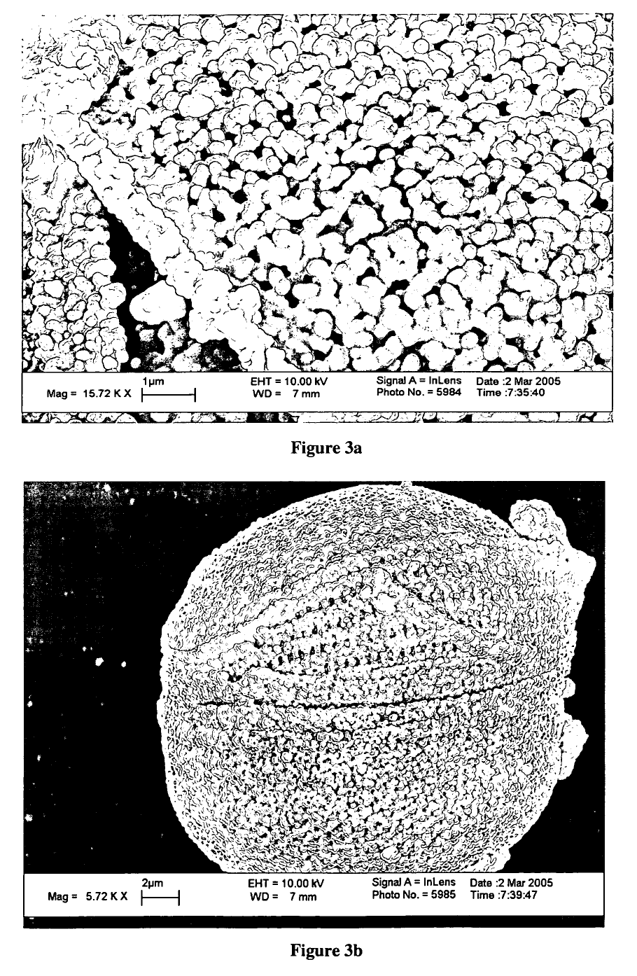

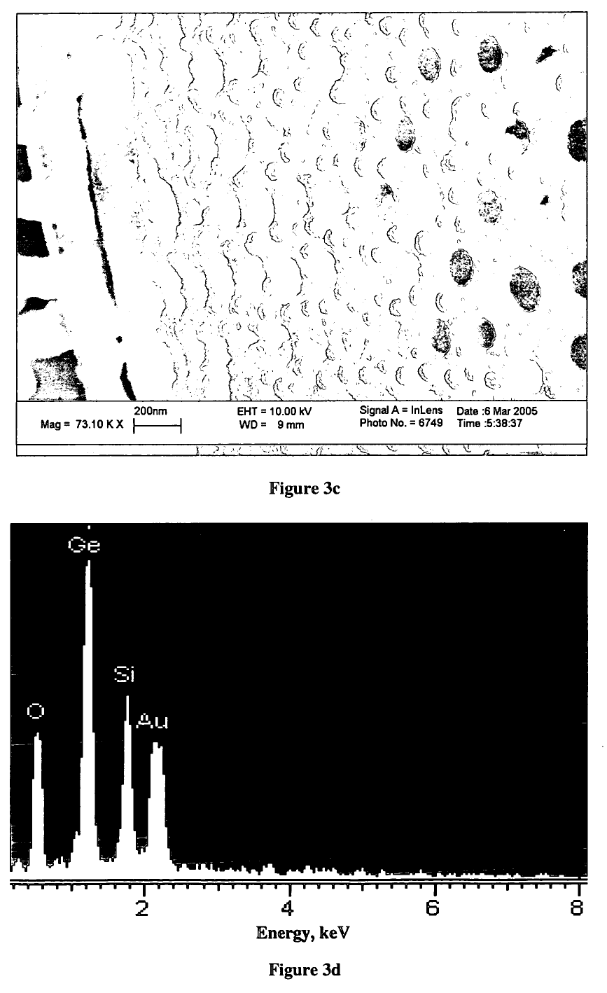

Secondary electron images of the resulting diatom microshells are shown in FIGS. 3a and b. Fine (<1 micrometer diameter) germania particles can be seen to coat the diatom microshell surfaces. This demonstrates that germanium formation had been induced on the diatom microshell surfaces through the action of the covalently attached Si41c peptide (i.e., germanium was not present in the starting silica-based diatom microshell template).

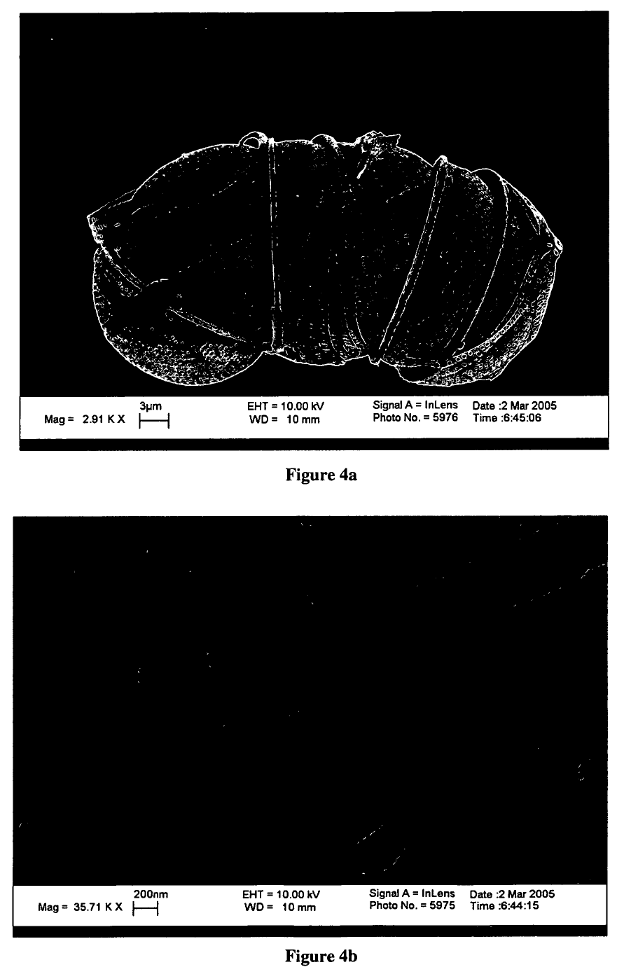

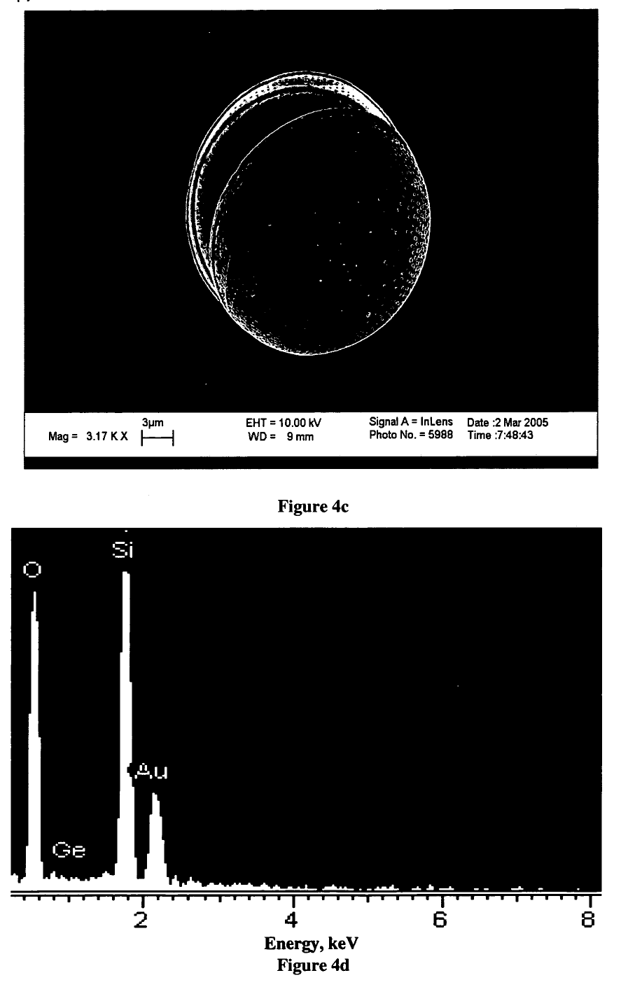

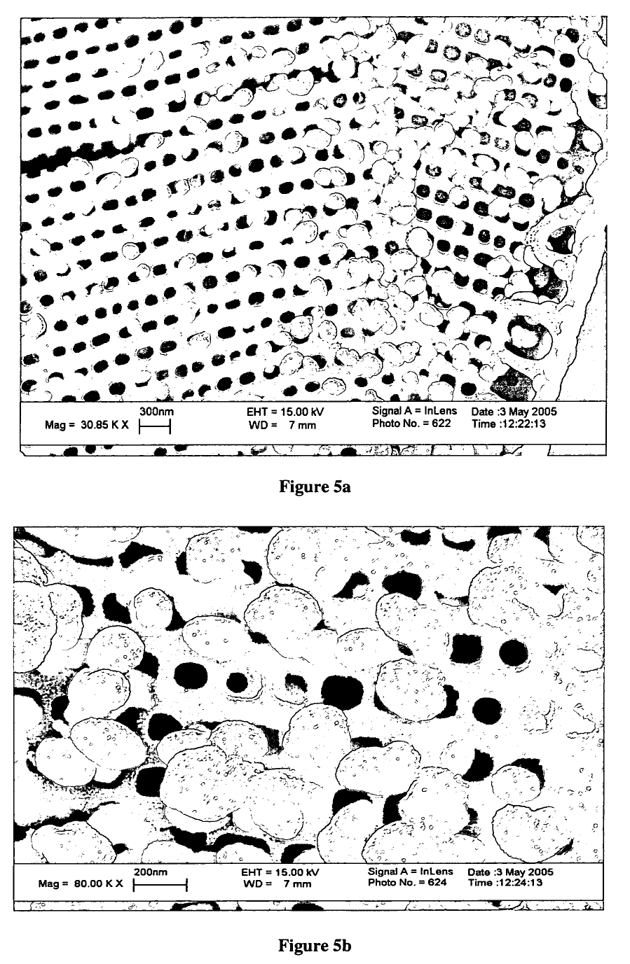

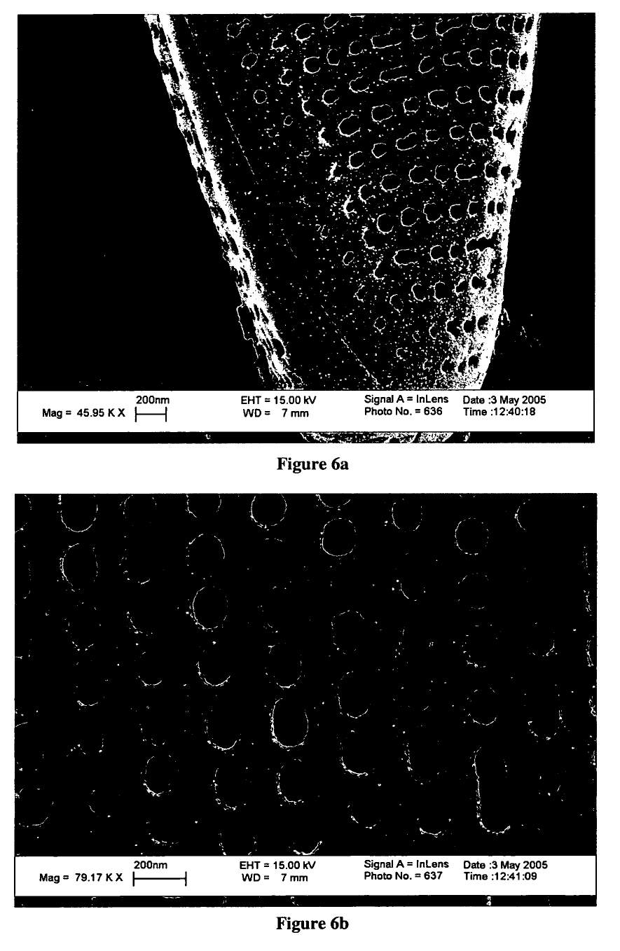

In order to confirm that the germania formation indicated in FIG. 3 resulted specifically from the presence of the peptide covalently attached to the diatom microshell surface, a “control” experiment was conducted. The control experiment was conducted in a similar manner as described above, except that the microshells were exposed to a solution of the TCEP-HCl/HEPES buffer solution with an equivalent volume of water, instead of the Si41c peptide. Secondary electron images of the resulting diatom microshells are shown in FIGS. 4a and b. The submicron particles detected in the images of FIGS. 3a and b were absent in the images of FIGS. 4a and b. Hence, the covalent attachment of mineralizing peptides clearly acted to promote the formation of germanium oxide on the diatom microshell surfaces.

While the invention has been disclosed in its preferred forms, it will be apparent to those skilled in the art that many modifications, additions, and deletions can be made therein without departing from the spirit and scope of the invention and its equivalents as set forth in the following claims.

1. A biologically-assembled three-dimensional structure, comprising:
a biologically-derived microscale-to-nanoscale mineralized template;
at least one precipitation-inducing biological agent attached to said template; and
at least one solid precipitated onto said biological agent under the action of said precipitation-inducing biological agent;
wherein said solid material is different from said template material.

2. The biologically-assembled three-dimensional structure of claim 1, wherein said biologically-derived microscale-to-nanoscale mineralized template is generated by a naturally occurring organism.

3. The biologically-assembled three-dimensional structure of claim 1, wherein said biologically-derived microscale-to-nanoscale mineralized template is generated by a genetically modified organism.

4. The biologically-assembled three-dimensional structure of claim 1, wherein said solid is precipitated from a precursor solution.

5. The biologically-assembled three-dimensional structure of claim 4, wherein said precursor solution comprises gas solutions, liquid solutions, solid solutions, and combinations thereof.

6. The biologically-assembled three-dimensional structure of claim 1, wherein said solid material is an amalgam of active and inactive material.

7. The biologically-assembled three-dimensional structure of claim 6, wherein said solid material comprises proteins.

8. The biologically-assembled three-dimensional structure of claim 7, wherein said proteins are enzymes.

9. The biologically-assembled three-dimensional structure of claim 1, wherein said solid is selected from the group consisting of a solid metal, a solid metal alloy, a solid metal mixture, a solid ceramic, a solid ceramic alloy, a solid ceramic mixture, a solid organic material, a solid organic alloy, a solid organic mixture, or combinations thereof.

10. A microscale-to-nanoscale device incorporating the biologically-assembled three-dimensional structure of claim 1.

11. The microscale-to-nanoscale device of claim 10, wherein said device is selected from the group consisting of microcatalysts, microreactors, microcapsules, microsensors, microtags, microactuators, microtransducers, microbearings, microlenses, microdiffraction gratings, microrefraction gratings, microemitters, microphosphors, micromirrors, microfilters, micromembranes, microneedles, microdies, microhinges, microswitches, microbearings, micronozzles, and microvalves.

12. A method for fabricating microscale-to-nanoscale structures comprising:
providing at least one biologically-derived microscale-to-nanoscale mineralized template;
attaching at least one precipitation-inducing biological agent to the template;
exposing the precipitation-inducing biological agent on the template to at least one precursor solution containing a precursor to a solid material; and
precipitating the solid material onto the biological agent;
wherein the solid material is different from the template material.

13. The method according to claim 12, wherein the step of providing at least one biologically-derived microscale-to-nanoscale mineralized template comprises using a naturally-occurring biological organism to assemble the template.

14. The method according to claim 12, wherein the step of providing at least one biologically-derived microscale-to-nanoscale mineralized template comprises using a genetically-modified biological organism to assemble the template.

15. The method according to claim 12, wherein the step of providing at least one biologically-derived microscale-to-nanoscale mineralized template further comprises the step of altering the chemistry of the template by conducting a chemical reaction with the template prior to the step of attaching at least one precipitation-inducing biological agent to the template.

16. The method according to claim 15, wherein the step of altering the chemistry of the biologically-derived microscale-to-nanoscale mineralized template by conducting a chemical reaction with the template comprises conducting an oxidation-reduction reaction, an additive reaction, or a metathetic reaction.

17. The method according to claim 12, wherein the precipitation-inducing biological agent is selected from the group consisting of a cell(s), an organelle in a cell, nucleotides, proteins, polypeptides, polyamines, polysaccharides, and combinations thereof.

18. The method according to claim 12, wherein the step of attaching at least one precipitation-inducing biological agent to the at least one biologically-derived microscale-to-nanoscale mineralized template comprises attaching the biological agents to the template through covalent bonding, ionic bonding, Van der Waals bonding, or combinations thereof.

19. The method according to claim 12, wherein the step of attaching at least one precipitation-inducing biological agent to the at least one biologically-derived microscale-to-nanoscale mineralized template comprises attaching the biological agents to the template prior to the step of precipitating the solid material onto the template.

20. The method according to claim 12, wherein the step of attaching at least one precipitation-inducing biological agent to the at least one biologically-derived microscale-to-nanoscale mineralized template comprises attaching the biological agents to the template following the step of precipitating the solid material.

21. The method according to claim 12, wherein the step of exposing the at least one precipitation-inducing biological agent on the at least one biologically-derived microscale-to-nanoscale mineralized template to at least one precursor solution containing a precursor to a solid material comprises localizing the precipitation-inducing biological agents to at least one surface of the template through incorporation within a coating applied to the template.

22. The method according to claim 12, wherein the step of precipitating the solid material onto the at least one biologically-derived microscale-to-nanoscale mineralized template further comprises altering the chemistry of the precipitate on the template by a chemical reaction selected from the group consisting of oxidation-reduction reactions, metathetic reactions, and additive reactions.

23. The method according to claim 12, further comprising the step of applying a synthetically-derived coating to the at least one biologically-derived microscale-to-nanoscale mineralized template prior to the step of attaching the at least one precipitation-inducing biological agent to the template.

24. The method according to claim 12, further comprising the step of selectively removing all or part of the at least one biologically-derived microscale-to-nanoscale mineralized template following the step of precipitating the solid material onto the template.

25. The method according to claim 12, wherein the method is performed at a temperature of 200° C. or less.

26. The method according to claim 12, wherein the method is performed at a temperature of 100° C. or less.

27. A microscale-to-nanoscale device incorporating the microscale-to-nanoscale structure formed using the method of claim 12.

28. The device of claim 27, wherein the microscale-to-nanoscale structure is used in a device selected from the group consisting of microcatalysts, microreactors, microcapsules, microsensors, microtags, microactuators, microtransducers, microbearings, microlenses, microdiffraction gratings, microrefraction gratings, microemitters, microphosphors, micromirrors, microfilters, micromembranes, microneedles, microdies, microhinges, microswitches, microbearings, micronozzles, and microvalves.

29. A biologically-assembled three-dimensional device, comprising:
a biologically-derived microscale-to-nanoscale mineralized template;
at least one precipitation-inducing biological agent attached to said template; and
at least one solid precipitated onto said biological agent under the action of said precipitation-inducing biological agent;
wherein said biologically-derived microscale-to-nanoscale mineralized template material is a metal, a ceramic, a semiconductor, an organic, or any combination thereof.

30. The biologically-assembled three-dimensional device according to claim 29, wherein said biologically-derived microscale-to-nanoscale mineralized template may be generated by an organism that is exposed to conditions different from the environment in which the organism is typically found in order to generate a different template pattern.

31. The biologically-assembled three-dimensional device according to claim 29, wherein said solid is precipitated from a precursor solution.

32. The biologically-assembled three-dimensional device according to claim 31, wherein said precursor solution comprises gas solutions, liquid solutions, solid solutions, and combinations thereof.

33. The biologically-assembled three-dimensional device of claim 29, wherein said solid material is an amalgam of active and inactive material.

34. The biologically-assembled three-dimensional device of claim 33, wherein said solid material comprises proteins.

35. The biologically-assembled three-dimensional device of claim 34, wherein said proteins are enzymes.

36. The biologically-assembled three-dimensional structure of claim 29, wherein said solid is selected from the group consisting of a solid metal, a solid metal alloy, a solid metal mixture, a solid ceramic, a solid ceramic alloy, a solid ceramic mixture, a solid organic material, a solid organic alloy, a solid organic mixture, or a combination thereof.

37. The microscale-to-nanoscale device of claim 29, wherein said device is selected from the group consisting of microcatalysts, microreactors, microcapsules, microsensors, microtags, microactuators, microtransducers, microbearings, microlenses, microdiffraction gratings, microrefraction gratings, microemitters, microphosphors, micromirrors, microfilters, micromembranes, microneedles, microdies, microhinges, microswitches, microbearings, micronozzles, and microvalves.
